(19) United States
(12) Patent Application Publication
(10) Pub. No.: US 2018/0193110 A1
(43) Pub. Date: Jul. 12, 2018

(54) ADJUSTABLE WIRE HOOK FOR ORTHODONTIC ELASTICS

(71) Applicant: James Michael Crouse, Quantico, MD (US)

(72) Inventor: James Michael Crouse, Quantico, MD (US)

(21) Appl. No.: 15/713,863

(22) Filed: Sep. 25, 2017

Related U.S. Application Data
(60) Provisional application No. 62/444,410, filed on Jan. 10, 2017.

(51) Int. Cl. A61C 7/12

(52) U.S. Cl. CPC A61C 7/12; A61C 7/36

(57) ABSTRACT

An orthodontic hook device for holding orthodontic elastics includes a wire loop hook with a first loop, a center loop, and a third loop. The first loop and the third loop are bonded directly to a surface of a tooth with a resin composite. This avoids the need for attaching a mesh to the tooth.

### CROSS-REFERENCE TO RELATED APPLICATION

This application claims the benefit of priority of U.S. provisional application No. 62/444,410, filed Jan. 10, 2017, the contents of which are herein incorporated by reference.

### BACKGROUND OF THE INVENTION

The present invention relates to orthodontic attachment devices, or more particularly, to a device to connect orthodontic elastics and orthodontic wires.

Rubber bands are often an important part of orthodontic treatment. They provide the connective force necessary to move the teeth and jaw into the proper alignment. With braces or with other orthodontic treatments, interarch rubber bands, are used to adjust bite and jaw position. These are connected to brackets with hooks, often connecting the top tooth bracket with the bottom tooth bracket to help adjust the position of the teeth in the mouth and the position of the jaw. Brackets are square metal pieces bonded directly to the teeth. The brackets with hooks are placed along the side of the mouth; one or more on both the left and right side of the top and bottom set of teeth. A band is attached on each side of the mouth from one hook/bracket to the other. There are instances where there is a need to place orthodontic elastics on teeth that do not have orthodontic brackets, such as with clear removable aligners and teeth that are partially erupted or severely displaced.

Most attachments of this type include a button, wire hook, or eyelet that is welded to a mesh bonding pad, on a bracket or on an orthodontic band. These hooks or buttons protrude from the tooth, making them less comfortable and more prone to breakage. The mesh pad-tooth interface creates a ledge that is also prone to being dislodged through biting forces. Inadequate integration of bonding cement into the mesh can also be a source of bond failure. Further, the mesh pad works better on flat or slightly curved surfaces such as the facial or lingual surfaces of the teeth. They do not work as well on the occlusal surfaces because of poor adaptation of the mesh pad. The cements that are used to bond these attachments to the enamel of teeth are usually light cured, be an adequate amount of enamel surface is needed to transmit the curing light to the bonding material under the mesh pad.

There exists a need for attachments that are bonded directly to the teeth for orthodontic elastics and other elastomeric products, (such as power chain and elastic thread and arch wires) are simple to bond to any shaped surface, easy to modify, and are not prone to breakage.

### BRIEF DESCRIPTION OF THE DRAWINGS

FIG. 1 is a perspective view of the invention in use;

FIG. 2 is a detail perspective view of the invention;

FIG. 3 is an alternative embodiment of the invention;

FIG. 4 is an alternative embodiment of the invention;

FIG. 5 is an alternative embodiment of the invention; and

FIG. 6 is an alternative embodiment of the invention.

### SUMMARY

An orthodontic hook device comprises a wire loop hook with a first loop, a center loop, a third loop, and a resin composite, wherein the first loop and the second loop are bonded directly to a surface of a tooth with the resin composite.

In one embodiment, the center loop is a closed loop. In one embodiment, the orthodontic device is used as attachment point for elastics. In another embodiment, the first loop and third loop are closed loops.

In another embodiment, the center loop is an eyelet through which an arch wire is placed. In another embodiment, the center loop is an eyelet through which an elastic thread is placed.

In one embodiment, the wire loop hook is made of stainless-steel. In one embodiment, the first loop and the third loop are embedded underneath the resin composite.

In one embodiment, the first and second loop are positioned flat against the tooth surface and the center loop protrudes off the tooth to accept an elastic.

### DETAILED DESCRIPTION OF THE INVENTION

The following detailed description is of the best currently contemplated modes of carrying out exemplary embodiments of the invention. The description is not to be taken in a limiting sense, but is made merely for illustrating the general principles of the invention, since the scope of the invention is best defined by the appended claims.

Currently, bondable hooks, buttons and eyelets protrude from the tooth which makes them less comfortable and more prone to breakage. Most attachments of this type consist of a button, wire hook, or eyelet that is welded to a mesh bonding pad on the bracket, which also adds to the extended protrusion of the hook. These attachments are not easily modified once they are bonded to the tooth. The current invention reduces these problems.

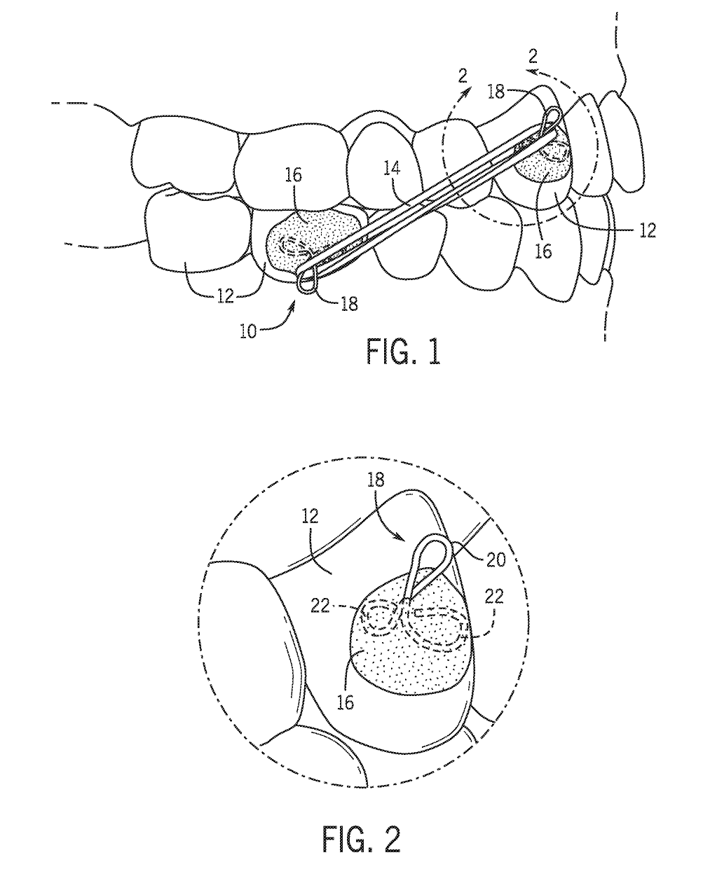

Broadly, an embodiment of the present invention provides a wire loop hook 18 that is directly bonded to the enamel of teeth 12 as shown in FIG. 1. A flowable composite resin bond 16 is used to bond the hook 18 to the teeth 12. The composite resin bond 16 is placed so that there is a smooth transition between the tooth surface and the resin bond 16 holding the hook.

Advantageously, because of this smooth transition, this hook is less susceptible to breakage from eating. The hook 18 and its loops are easily modified to be bonded to the desired tooth surface to act as an elastic hook or eyelet and to accept an arch wire or elastic in the direction desired. In addition, it can be adjusted once it's bonded to the tooth. It is to be understood that any suitable and biocompatible attachment means can be used to bond the hook to the tooth.

As shown in the embodiment of FIG. 1, two hooks 18 are holding an orthodontic elastic 14. Each end loop of the two hooks 18 is embedded in the composite resin 16 and a center loop 20 is bent to accept the orthodontic elastic. The center loop creates an eyelet portion that is used through which to place elastics or other orthodontic devices.

Details of the hook 18 are shown in the embodiment of FIG. 2. The hook 18 includes the center loop 20 and two embedded hooks 22, which are embedded within and by the resin bond 16 to tooth 12.

Advantageously, the lack of a mesh pad eliminates several risks for the wearer; no weld can break, and no mesh pads can dislodge through biting forces or inadequate integration of bonding cement into the mesh, and there is no inadequate curing of the cement under the mesh pad.

In one embodiment, the hook is made of about a 0.012 inches diameter dead, soft stainless-steel wire that is bent into a series of three loops. It is to be understood the dimensions of the wire can be any suitable size or diameter. It is also to be understood that the hook can be made of any suitable and biocompatible metallic material.

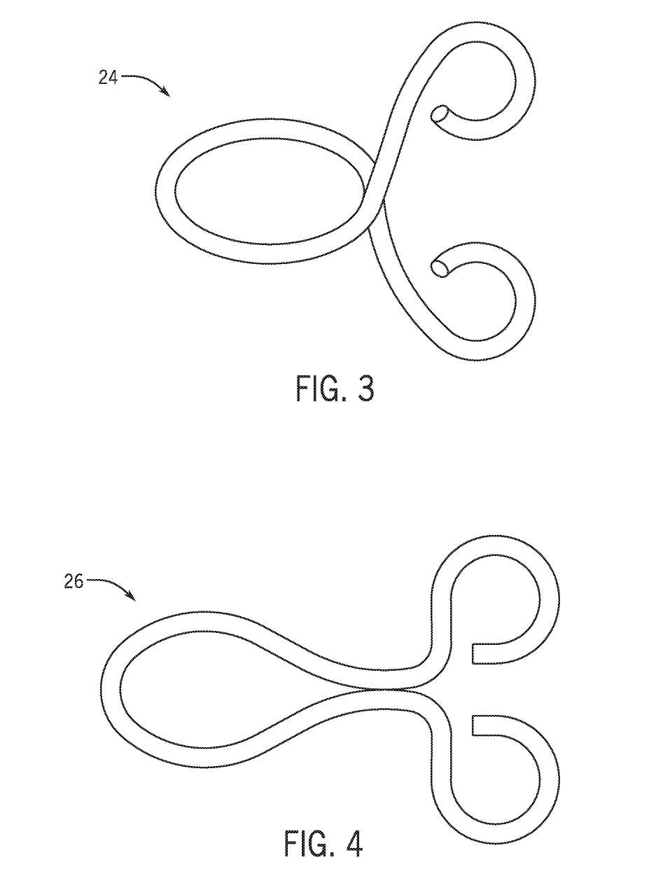

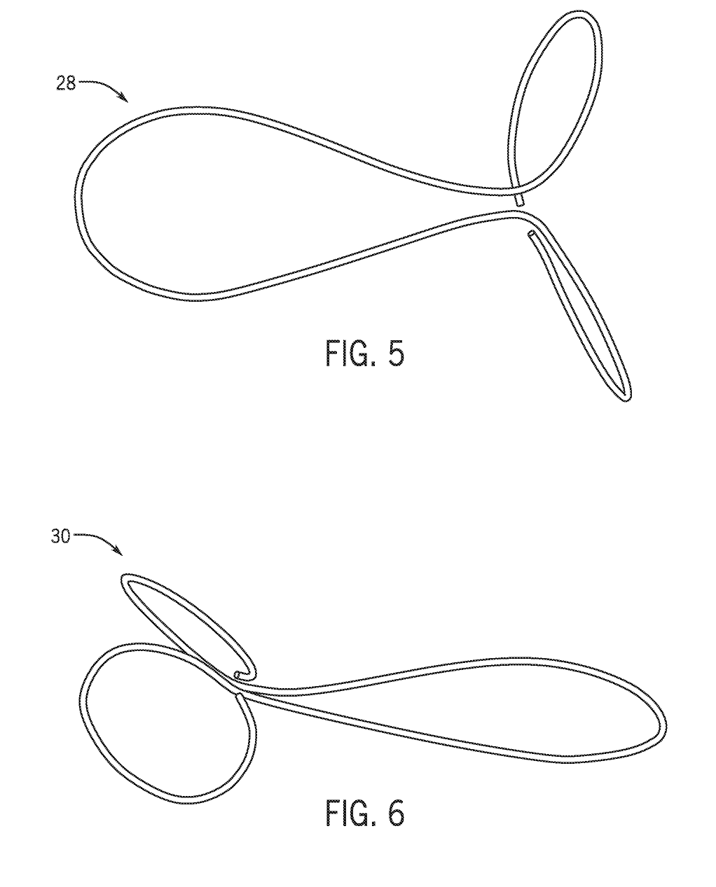

FIG. 3 shows an embodiment of an alternative hook shape 24. FIG. 4 shows an additional embodiment of alternative hook shape 26. FIG. 5 shows an additional embodiment of an alternative hook shape 28. FIG. 6 shows an alternative embodiment of a hook shape 6. The end loops can be open loops or closed loops. It is to be understood that the hook and loops can be configured into various three looped shapes that have the same function.

In an alternative embodiment, the hook can include four loops, wherein three loops are embedded in the resin and one loop protrudes from the tooth.

In one embodiment, the loop is used as an eyelet through which arch wires or elastic thread can be placed. The eyelet is helpful in bringing a severely displaced or impacted tooth into the arch.

Advantageously, the bonded hook can be used instead of an attachment that has a mesh pad to attach to the tooth. This hook is of lower profile, more aesthetic and less prone to breakage and easy to modify to bond to enamel surfaces other that the buccal and lingual surfaces such as cusp tips, and can be modified to act as a hook or an eyelet. The hook can be used with traditional metal braces, clear braces, clear removable aligners, or for any needed orthodontic purpose in humans or animals.

It should be understood, of course, that the foregoing relates to exemplary embodiments of the invention and that modifications may be made without departing from the spirit and scope of the invention as set forth in the following claims.

What is claimed is:

1. An orthodontic hook device comprising;
a wire loop hook with a first loop, a center loop, and a third loop; and
a resin composite, wherein the first loop and the second loop are bonded directly to a surface of a tooth with the resin composite.

2. The orthodontic hook device of claim 1, wherein the center loop is a closed loop.

3. The orthodontic hook device of claim 1, wherein the orthodontic device is used as attachment point for elastics.

4. The orthodontic hook device of claim 1, wherein the first loop and third loop are closed loops.

5. The orthodontic hook device of claim 1, wherein the center loop is an eyelet through which an arch wire is placed.

6. The orthodontic hook device of claim 1, wherein the center loop is an eyelet through which an elastic thread is placed.

7. The orthodontic hook device of claim 1, wherein the wire loop hook is made of stainless-steel.

8. The orthodontic hook device of claim 1, wherein the first loop and the third loop are embedded underneath the resin composite.

9. The orthodontic hook device of claim 1, wherein the first and second loop are positioned flat against the tooth surface and the center loop protrudes off the tooth surface to accept an elastic.
